(19) United States
(12) Patent Application Publication
(10) Pub. No.: US 2019/0021275 A1
(43) Pub. Date: Jan. 24, 2019

(54) Expandable Pet Carrier

(71) Applicants: Muhammad Bilal Chaudhry, Mississauga (CA); Suhaib Sajjad, Oakville (CA)

(72) Inventors: Muhammad Bilal Chaudhry, Mississauga (CA); Suhaib Sajjad, Oakville (CA)

(21) Appl. No.: 16/034,621

(22) Filed: Jul. 13, 2018

Related U.S. Application Data
(60) Provisional application No. 62/534,456, filed on Jul. 19, 2017.

(51) Int. Cl. A01K 1/02

(52) U.S. Cl. CPC A01K 1/0254; A01K 1/0272; A01K 1/029

(57) ABSTRACT

An expandable pet carrier that provides additional space for a pet while traveling. The expandable pet carrier includes a housing with a base and a sidewall that forms a main compartment with at least one expandable compartment. An expandable side compartment is movable between a compact configuration and an expanded configuration that pivots away from the housing to increase the side of the interior volume of the expandable pet carrier. A rear panel is openable and can be positioned within a channel that is formed between the base and a cushion. A fastener strap located within the housing can secure and restrain a pet while inside the carrier.

### CROSS REFERENCE TO RELATED APPLICATIONS

This application claims the benefit of U.S. Provisional Application No. 62/534,456 filed on Jul. 19, 2017. The above identified patent application is herein incorporated by reference in its entirety to provide continuity of disclosure.

### BACKGROUND OF THE INVENTION

The present invention relates to pet carriers. Many pet carriers are weak and unstable, causing them to kink or bend when carrying pets, which can be uncomfortable and awkward. Additionally, pet carriers are typically designed to take up the least amount of space, especially while traveling in an airplane. Unfortunately, this can, in turn, make pets feel trapped and enclosed and may even affect their mental health long-term. Another issue with conventional pet carries is that toys and pet food must be stored in other bags, which can be inconvenient. Many expandable pet carriers also sag when expanded. Further, many carriers cannot fit under airplane seats, preventing travelers from taking their pet aboard an airplane. To address these concerns, the present invention provides an expandable pet carrier than can maintain a collapsed configuration for tight spaces, such as under an airplane seat, and an expanded configuration that provides more space for the animal.

Devices have been disclosed that relate to pet carriers. However, these devices fail to disclose a pet carrier having a main compartment, at least one expandable side compartment, and an expandable front compartment with ribbed fabric that telescopically folds to create an accordion-like structure.

In view of the above-identified devices, it is submitted that the present invention substantially diverges in design elements from the known art and consequently it is clear that there is a need in the art for an improvement to existing expandable pet carriers. In this regard the instant invention substantially fulfills these needs.

### SUMMARY OF THE INVENTION

In view of the foregoing disadvantages inherent in the known types of expandable carriers, the present invention provides an expandable pet carrier wherein the same can be utilized for providing comfort and extra room for pets while travelling.

It is therefore an object of the present invention to provide a new and improved expandable pet carrier.

It is another object of the present invention to provide an expandable pet carrier having a housing with a base and a sidewall extending upwardly therefrom forming a main compartment with at least one expandable compartment comprised of ribbing fabric in the folds being disposed at a first end of the housing.

Another object of the present invention is to provide an expandable pet carrier wherein the expandable compartment is movable between a compact configuration and expanded configuration with a support panel having a lower layer disposed on an elongated rectangular base and a plurality of fasteners configured to restrain a pet while inside the carrier.

Yet another object of the present invention is to provide an expandable pet carrier wherein an alternative embodiment includes a sleeve to receive a suitcase handle and an access port in the back of the carrier with an additional strap for added for support.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the expandable pet carrier in a collapsed configuration.

FIG. 2 shows a perspective view of an embodiment of the expandable pet carrier in an expanded configuration.

FIG. 3 shows a perspective view of an embodiment of the expandable carrier in an expanded configuration with a call out view of at least one clip.

FIG. 4 shows a side view of an embodiment of the expandable pet carrier in a collapsed configuration.

FIG. 5A shows a perspective view of an embodiment of the expandable pet carrier in a closed position.

FIG. 5B shows a perspective of an embodiment of the expandable pet carrier in an intermediate position.

FIG. 5C shows a perspective view of an embodiment of the expandable pet carrier in an expanded position.

### DETAILED DESCRIPTION OF THE INVENTION

Reference is made herein to the attached drawings. Like reference numerals are used throughout the drawings to depict like or similar elements of the expandable pet carrier. The figures are intended for representative purposes only and should not be considered to be limiting in any respect.

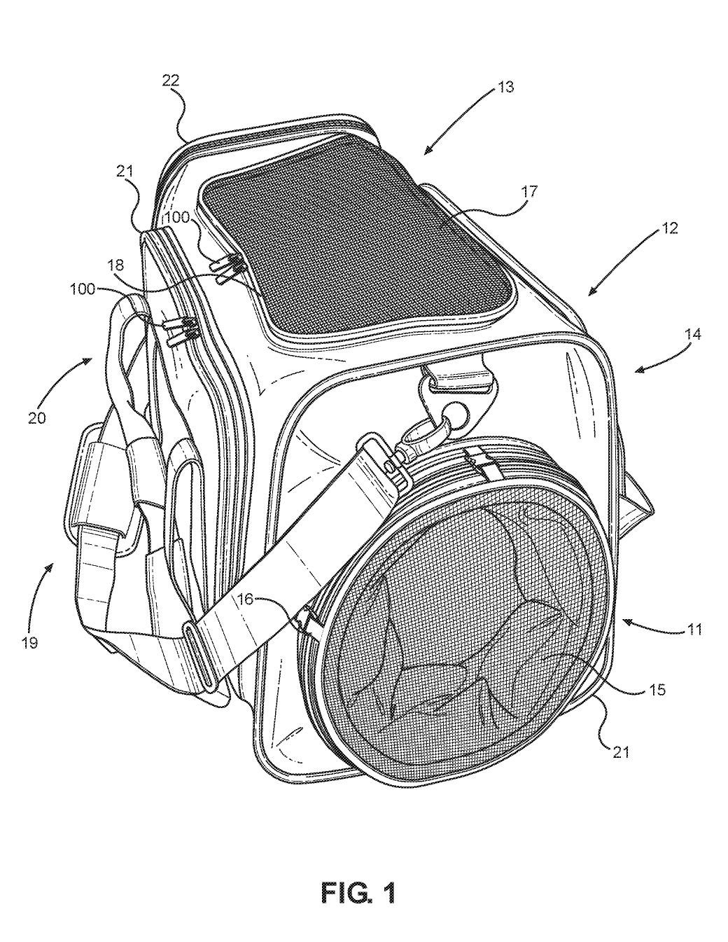

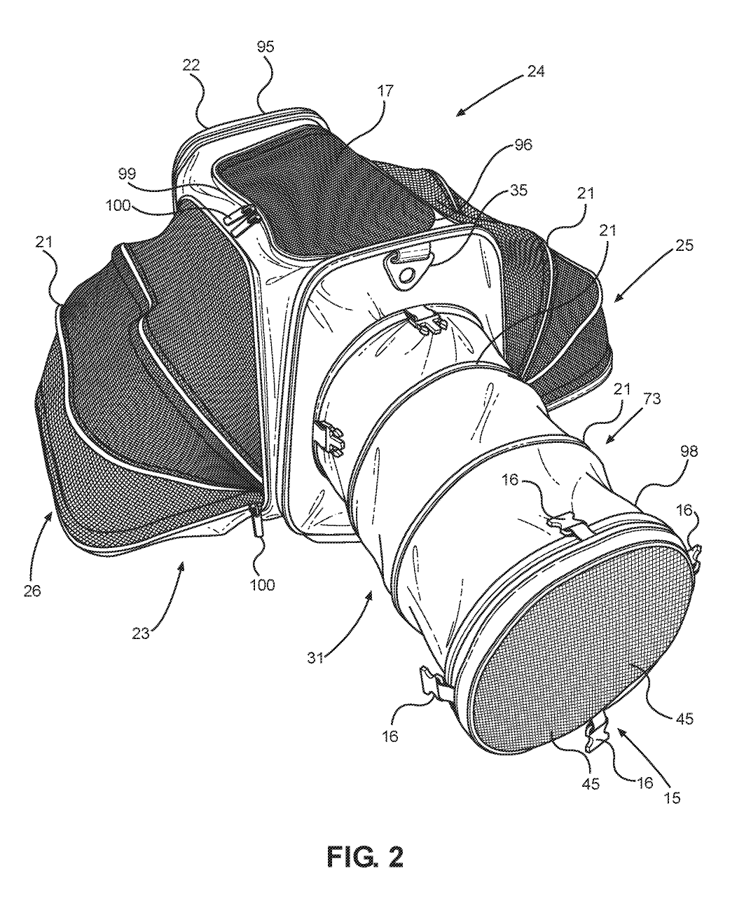

Referring to FIGS. 1 and 2, there is shown a perspective view of an embodiment of the expandable pet carrier in a collapsed and expanded configuration, respectfully. The expandable pet carrier 10 comprises a housing 14 including a base 11, at least one sidewall panel 12 extending upwardly therefrom, and an upper panel 17 forming a main compartment 13. The sidewall panel 12 is disposed on a left sidewall 26 and a right sidewall 25 and is configured to form a portion of the left and right sidewall 26, 25 in an expanded configuration and to form an interior volume in a collapsed position. In the collapsed position, the sidewall panel 12 pivots about a pivot point, whereby the right sidewall 25 and left sidewall are affixed to the frame member and the housing 14 to form the boundary of at least one expandable side compartment 20. The interior volume of the expandable side compartment 20 joins the main compartment 13 to provide for a spacious void area within the housing 14. In one embodiment, an interior side of the right sidewall 25 aligns with the base 11 to form a flat surface when rotated about the pivot point. In this way, the base 11 and right sidewall 25 form an unobstructed and planar area of which a pet housed within the expandable pet carrier 10 has increased surface area to maneuver and lay.

In the shown embodiment, the right sidewall 25 and the left sidewall 26 of the expandable side compartment 20 includes a series of support frame members 21, wherein the support frame members 21 are disposed at intervals therealong to maintain a desired shape of the expandable side compartment 20. The support frame members 21 are made of a ribbed material. As shown in FIG. 2, the expandable pet carrier 10 comprises a pair of expandable side compartments 20 disposed on opposed sides of the housing 14. In one embodiment, the expandable pet carrier 10 comprises a single expandable side compartment 20.

In the shown embodiment, the main compartment 13 forms a rectangular shape when the expandable pet carrier 10 is in the collapsed configuration. In one embodiment, the base 11 and sidewall panel 12 are made of an Oxford fabric or a similar soft fabric. In another embodiment, the expandable pet carrier 10 is adapted to hold pets up to fourteen pounds comfortably and is configured to fit under an airplane seat in a retracted configuration at 18″L×11″W×1.5″ H.

In the shown embodiment, the upper panel 17 of the expandable pet carrier 10 is affixed along a perimeter thereof via a fastener 18. The upper panel 17 provides for access to the main compartment 13 when in an open position and drawn away from the sidewalls 25, 26 adjacent the fastener. The upper panel 17 extends across the length of the expandable pet carrier 10 between the opposing ends 95, 96. In one embodiment, the upper panel 17 includes a mesh construction allowing the free flow of air to pass therethrough. The open mesh being made of a unique mesh grid pattern to enhance ventilation. In other embodiments, the panel is solid. In other embodiments, the panel is integrally and permanently affixed to the housing 14.

In the shown embodiment, the expandable pet carrier 10 further comprises a shoulder strap 19 that is removably secured to a buckle 35 attached to the housing 14. In one embodiment, the shoulder strap 19 is removably affixed to a pair of buckels 35 disposed on opposing sides of the housing 14.

In the shown embodiment, a support frame member 21 extends around an entire perimeter of the ends 95, 96 of the housing 14, forming a generally planar side face from which a front panel 15 protrudes outwardly therefrom. In one embodiment, the support frame member 21 comprises a flexible material, such as rubber, that assists with the maintenance of the overall shape of the expandable pet carrier 10. In the shown embodiment, the front panel 15 comprises a circular mesh panel that is movable between a compact configuration (as shown in FIG. 1) and an expandable configuration (as shown in FIG. 2). In the expandable configuration, the front panel 15 is positioned away from the ends 95, 96 of the housing 14 to form an expandable front compartment 98.

In the shown embodiment, the front panel 15 is disposed on the sidewall panel 12 at one of the ends 95, 96 of the housing 14. The front panel 15 is configured to form a portion of the sidewall panel 12 in the compact configuration and to form an interior volume of the expandable front compartment 98 in the expandable configuration. In the expandable configuration, the front panel 15 is selectively moved away from the ends, 95, 96 of the housing 14 and the sidewall panel 12 of the housing 14 now forms the boundary of the expandable front compartment 98. The interior volume of the expandable front compartment 98 joins the main compartment to provide for a spacious void area within the housing 14. In the shown embodiment, the back panel 22 of the expandable front compartment 98 includes a series of support members 21 at intervals therealong, whereby the support member 21 is configured to maintain a desired shape of the expandable front compartment 98. As shown in FIG. 2, the expandable pet carrier 10 comprises a single expandable front compartment 98 disposed on ends 95, 96 of the housing 14. In the shown embodiment, the front panel 15 and the corresponding front panel 15 form a cylindrical tube shape 31 extending from the housing 14 in the expandable configuration.

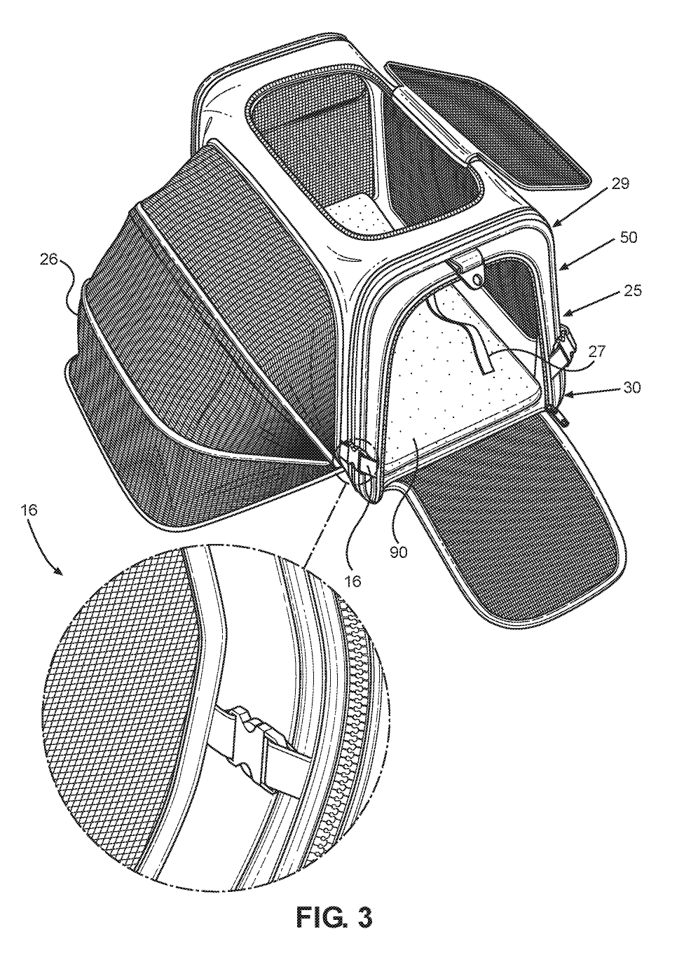

In one embodiment, the front panel 15, the upper panel 17, and a back panel 22 (shown in FIG. 3) comprise mesh material that is configured to allow a housed pet to easily see out of the carrier and allows air to circulate freely into the main compartment 13 keeping the pet from overheating and providing a fresh supply of air.

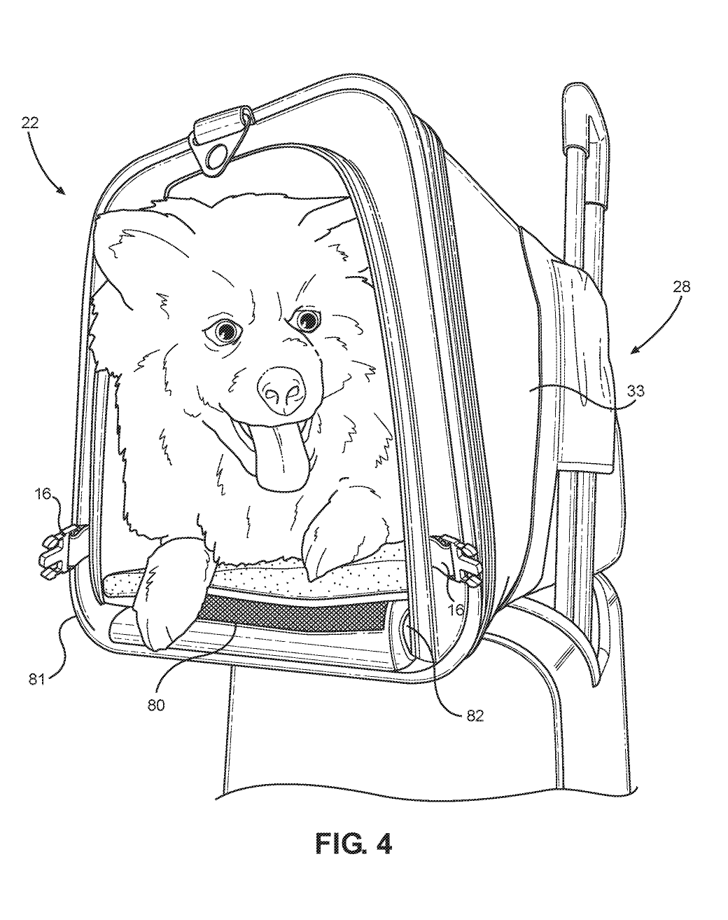

Referring now to FIGS. 3 and 4, there is shown a perspective view of an embodiment of the expandable carrier in an expanded configuration with a call out view of the self-locking zipper, and a side view of an embodiment of the expandable carrier in a collapsed configuration.

In the shown embodiment, the expandable pet carrier 10 comprises the right sidewall 25 and the left sidewall 26 expanding away from each respective sidewall 25, 26 with a rigid material that allows the right sidewall 25 and the left sidewall 26 to hold its shape while in the expanded position. The expandable pet carrier 10 further comprises a movable configuration that allows the right sidewall 25 and the left sidewall 26 to move between a retracted position (shown in FIG. 1) and an expanded position (shown in FIG. 2) comprising a body 50 enclosing a space, the body 50 having a top panel 29 and bottom panel 30 connecting to the left and right sidewalls 25, 26 to create additional space for the pet. The top panel 29 and bottom panel 30 are configured to extend across a length of the expandable carrier 10 between the ends, 95, 96. As shown in FIG. 3, the left sidewall 26 pivots about a pivot point, and acts as a base 11 to the body of the carrier 10 in the expanded configuration. In this way, the base 11 and sidewall portion form an unobstructed and planar area within the body of the expandable carrier 10.

In the shown embodiment, a cushion pad 23 is removably disposed on a support panel 73 within the main compartment 13, wherein the cushion pad 23 covers a substantial portion of the base 11. The support panel 73 comprises a lower layer disposed on the base 11, wherein the support panel is made of a sturdy, dense material configured to support a pet's weight thereon. In addition, the cushion pad 23 is configured to support a pet positioned thereon. In one embodiment, a channel 82 is formed between the base 11 and the cushion pad 23 that is sized to receive a rear panel 22 therein. As shown in FIG. 4, the channel 82 extends along the main compartment 13 from the second end 81 towards the first end 80, the channel 82 sized to receive the rear panel 22 therein. As shown in FIG. 4, when the rear panel 22 is positioned within the channel 82 at the end 95 of the housing 14, it is open allowing a pet disposed therein to have free access to enter and egress therefrom.

In one embodiment, a pet housed within the expandable pet carrier 10 may be selectively restrained with a plurality of fasteners 27. As shown in FIG. 3, the fasteners 27 in this embodiment are straps removably secured to an interior of the expandable pet carrier 10. In one embodiment, the expandable pet carrier 10 further comprises an open pocket 28 on the outside perimeter of an outer compartment 33 wherein the open pocket 28 is adapted to fit a suit case handle therein. The open pocket 28 allows for a pet owner to secure the expandable pet carrier 10 to a handle of a suitcase while traveling on foot.

In another embodiment, the outer compartment 33 is disposed on the sidewall panel 12 and is configured to store pet necessities, such as food, a leash, or medicine. The pet necessities are secured inside the pocket compartment 20 by a self-locking zipper closure 100.

In one embodiment, the panels 17, 22 of the expandable pet carrier 10 are each removably secured to the housing 14 via a fastener. In the shown embodiment, the panels 17, 22 are secured via a self-locking zipper closure 100 wherein the self-locking zipper closure 100 is comprised of two closing zipper runners wherein the zipper runners move adjacent to one another and are configured to lock in position when closing the openings on the panels 17, 22. In this way, the pet is secured inside the expandable pet carrier 10 with no way to escape or inadvertently unzip one of the panels 17, 22.

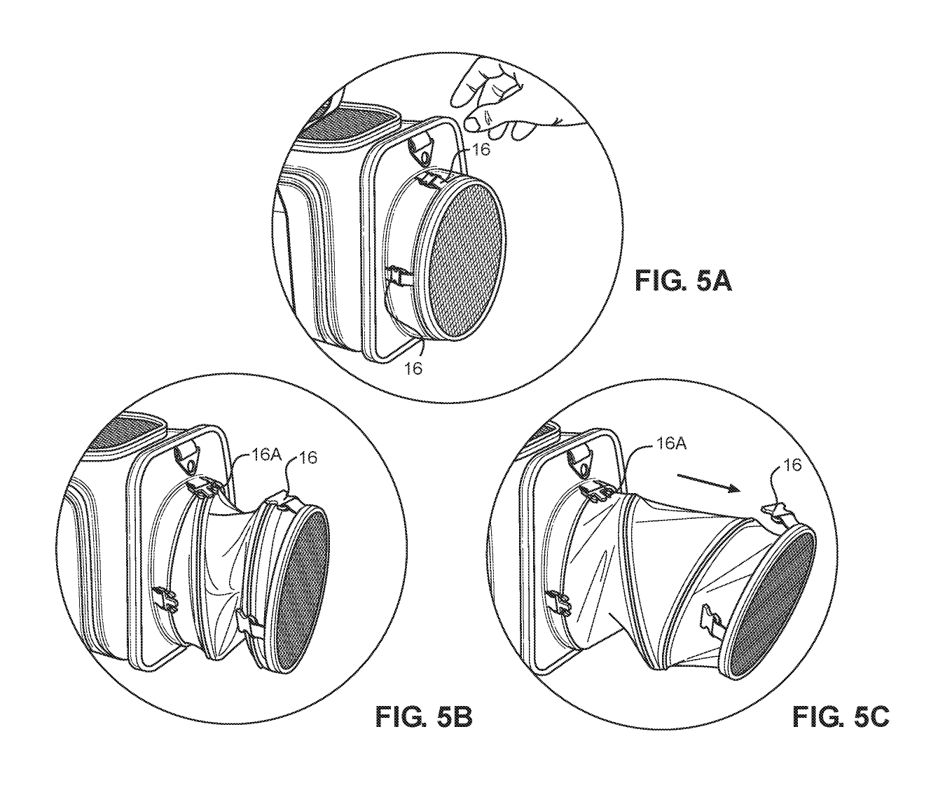

Referring now to FIGS. 5A, 5B, and 5C, there are shown a perspective view of an embodiment of the expandable pet carrier in a closed position, a perspective of an embodiment of the expandable pet carrier in an intermediate position, and a perspective view of an embodiment of the expandable pet carrier in an expanded position. In the shown embodiments, the front panel 15 is shown in a closed position (5A) wherein the clips 16, 16A are connected to each other to keep the front panel closed. FIG. 5B shows the front panel in an intermediate position wherein the front panel 15 is between the closed position and expanded position having the clips 16, 16A detached from each other. FIG. 5C shows the front panel 15 in an expanded position having the clips 16, 16A detached from each other.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An expandable pet carrier, comprising:
a housing including a base and at least one sidewall extending upwardly therefrom forming a main compartment;
at least one sidewall panel disposed on the sidewall configured to fold about a pivot point to form an expandable side compartment, the expandable side compartment movable between a compact configuration and an expanded configuration, wherein the sidewall panel forms a portion of the sidewall in the compact configuration;
a rear panel removably secured to a second end of the housing via a fastener;
a support panel comprising a lower layer disposed on the base;
a channel extending along the main compartment from the second end towards the first end, the pocket sized to receive the rear panel therein.

2) The expandable pet carrier of claim 1, wherein the support panel is made of a sturdy, dense material configured to support a pet's weight thereon.

3) The expandable pet carrier of claim 1, wherein the sidewall panel is configured to form a portion of a left sidewall and a right sidewall in an expanded configuration and to form an interior volume in a collapsed position.

4) The expandable pet carrier of claim 1, further comprises a pair of expandable side compartments disposed on opposing sides of the housing.

5) The expandable pet carrier of claim 1, further comprising a self-locking zipper configured to secure an opening on a panel.

6) The expandable pet carrier of claim 1, further comprising a top panel and bottom panel configured to connect to the left and right sidewalls to create additional space for the pet.

7) The expandable pet carrier of claim 1, wherein the top panel and bottom panel are configured to extend across the body of the expandable pet carrier between a front end and a back end.

8) The expandable pet carrier of claim 1, wherein a removable strap is selectively engageable with a buckle on opposing sides of the front end and the back end.

9) The expandable pet carrier of claim 1, wherein a front panel comprises a circular mesh panel disposed on the front end of the housing, the front panel configured to form an expandable front compartment movable between a retracted position and an expanded position.

10) The expandable pet carrier of claim 1, wherein a fastener is disposed on an inside of the main compartment and configured to restrain a pet therein.

11) The expandable pet carrier of claim 1 wherein the rear panel is in an open position having at least one portion connected to the sidewall.

12) The expandable pet carrier of claim 1, wherein the sidewall is comprised of at least one outer compartment for storage.

13) The expandable pet carrier of claim 1, further comprising an open pocket adapted to fit a suit case handle therein.
